(19) United States
(12) Patent Application Publication
(10) Pub. No.: US 2020/0273071 A1
(43) Pub. Date: Aug. 27, 2020

(54) Listener SDK-Based Enrichment of Indoor Positioning

(71) Applicant: POINT INSIDE, INC., Bellevue, WA (US)

(72) Inventor: Jonathan Alan CROY, Bellevue, WA (US)

(73) Assignee: POINT INSIDE, INC., Bellevue, WA (US)

(21) Appl. No.: 16/288,010

(22) Filed: Feb. 27, 2019

(51) Int. Cl. G06Q 30/02; G06Q 30/06; G01C 21/20

(52) U.S. Cl. CPC G06Q 30/0261; G01C 21/206; G06Q 30/0639; G06Q 30/0267

(57) ABSTRACT

An enriched Mobile Advertisement ID (MAID) database is built based on collected indoor positioning location detail records (LDRs). Indoor context is added into columns of each MAID entry in the enriched MAID database, providing enrichment and added value to the MAID database. An enrichment platform groups MAID entries with varying levels of location fidelity for sale by participants who have a vested interest in the creation of the enriched MAID database. An enrichment platform includes an enriched MAID database, which is built by an enrichment service. The enriched MAID database takes in location detail records, typically in a large batch, with mobile device location and timestamp associated with a given MAID. Each MAID row entry in the MAID database is annotated in additional database columns with indoor context, e.g., retail places or items that the mobile device dwelled on, and places that the mobile device walked past but didn't dwell.

### BACKGROUND OF THE INVENTION

### 1. Field of the Invention

The invention relates to identification, designation, and enrichment of a preferable indoor positioning technology which effectively provides higher quality location information particularly for indoor locations.

### 2. Background of Related Art

Mobile operating system (OS) providers such as Apple™ and Google™ have created a feature for mobile Apps to get a users' location through a call to the OS (aka “Core Location”). Behind the scenes, opaque to the App developer, the mobile operating system arbitrates the best location based on a compilation of satellite positioning (e.g., global positioning satellite (GPS)), cell tower triangulation, and WiFi positioning.

While this conventional method provides a best location, the present inventors have appreciated that the accuracy of Core Location solutions is not high enough fidelity to reliably produce location detail records and information of significant value to downstream consumers interested in indoor specifics relating to the Core Location.

Conventional indoor positioning systems and methods do not solve for the variability of technologies that can be deployed (are being deployed) in particular locations (venues), but rather arbitrate any position (indoor or outdoor) as a best position based on a compilation of GPS, cell tower triangulation, and WiFi positioning.

### SUMMARY OF THE INVENTION

In accordance with one aspect of the present invention, an enriched mobile Ad ID database comprises a plurality of location detail record rows corresponding to a marketing-based event, each of the plurality of location detail record rows including a plurality of columns. The plurality of columns comprise a Mobile Ad ID (MAID), a location of the MAID, a timestamp of the MAID, a place name associated with a location of the Mobile Ad ID, and at least one indoor context descriptor. The at least one indoor context descriptor enriches the respective one of the plurality of location detail records to provide a basis for grouping sub-pluralities of the plurality of location detail record rows.

A method of building an enriched mobile Ad ID database in accordance with another aspect of the invention comprises, for each of a plurality of mobile Ad IDs maintained within the enriched mobile Ad ID database, generating a location detail record row within the mobile Ad ID (MAID) database with a mobile Ad ID stored in a first column of the generated location detail record row. A location detail record (LDR) associated with the mobile Ad ID is stored in a second column of the generated location detail row. The mobile Ad ID is enriched by storing in one or more additional columns of the generated location detail record row at least one indoor context descriptor associated with the MAID, the at least one indoor context descriptor providing a basis for grouping the location detail record row with other location detail record rows.

Apparatus for building an enriched mobile Ad ID database in accordance with yet another aspect of the invention comprises, for each of a plurality of mobile Ad IDs maintained within the enriched mobile Ad ID database, means for generating a plurality of mobile Ad ID rows within the enriched mobile Ad ID database, means for storing a mobile Ad ID stored in a first column of each of the plurality of generated mobile Ad ID rows, means for storing a location detail record (LDR) associated with the mobile Ad ID, in a second column of each of the plurality of mobile Ad ID rows; and means for enriching the mobile Ad ID row by storing in one or more additional columns of the mobile Ad ID row at least one indoor context descriptor associated with the MAID, the at least one indoor context descriptor providing a basis for grouping the mobile Ad ID row with other mobile Ad ID rows.

In accordance with still another aspect of the invention, a method of selecting an indoor positioning system for use in creation of a given mobile Ad ID, comprises maintaining in a database a plurality of indoor positioning systems available at each of a respective plurality of venues. The plurality of indoor positioning systems for each of the respective plurality of venues are ranked based on a cost of each. A record from among the plurality of records is matched to a venue corresponding to a current position of a given mobile device. A desired indoor positioning system is determined from among the plurality of indoor positioning systems within the matching record, to transmit positioning for a given mobile Ad ID. A plurality of location detail records (LDRs) are collected from the desired indoor positioning system; and the collected plurality of location detail records are enriched at a summary level by a unique mobile identifier device ID to form a mobile Ad ID.

### BRIEF DESCRIPTION OF THE DRAWINGS

Features and advantages of the present invention will become apparent to those skilled in the art from the following description with reference to the drawings, in which:

FIG. 1 shows an exemplary enrichment platform including an enriched Mobile Ad ID database, in accordance with an embodiment of the invention.

FIG. 2 shows flow relevant to the enrichment platform.

FIG. 3 depicts a layered value approach to enrichment of MAID information by the enrichment platform.

### DETAILED DESCRIPTION OF ILLUSTRATIVE EMBODIMENTS

Some retail venues have invested in the development of custom Apps for mobile devices to enhance a customer's experience within their stores. Such Apps conventionally embed SDKs to monitor the location of the mobile device within their store. These SDKs provide monitoring signals (i.e., ‘listen’) to the app users' location by way of their mobile device, which is presumed to be on their person. The monitored location or movement information (aka Location Detail Records (LDRs)) is recorded and transmitted into a database.

The present inventor has appreciated that conventionally embedded third party SDKs listen to “core location” signals (e.g., coming from iOS and Android operating system calls), and that the accuracy of such core location signals is poor when a mobile device is indoors. Such poor quality location detail record (LDR) signals relating particularly to indoor locations cannot be reliably used to create audiences, or at least could be better utilized if they were of better value—particularly with indoor locations that include many audience-relevant locations such as product shelves or displays located within the indoor location.

As advertising continues to move to mobile devices, marketers and advertisers are looking for new and better ways to understand users through their mobile experience. The present invention enriches core location signals to provide added value to the core location signals, e.g., by comparing the location to a detailed indoor map. This enables the creation of better and more accurate audiences to which advertising campaigns may be targeted to (e.g., people in the market for a new car).

Today when a mobile user views an advertisement, the advertisements that are seen are specially selected and presented based on what the companies know about the individual that is using the mobile device. The ad viewing information is anonymously contained within a unique identifier for the device called a Mobile Ad ID (MAID). If an ad is viewed, that information is sent (anonymously again) to the company. Armed with this information about the viewers of their advertisements and the subsequent action, companies are able to further refine how they target and attract the right kinds of customers.

Whereas most conventional systems can tell you where a MAID was triggered, e.g., inside of an airport or a mall, the present invention takes this further by enriching the location information for the MAID. The invention provides the unique capability to add indoor context to collected data using indoor maps that include, e.g., retail information at given locations, and by comparing inputs such as location, accuracy, and timestamps to the indoor maps.

The present invention also appreciates that many venue owners have deployed indoor positioning systems, and that some venues may have multiple indoor positioning systems deployed. For example, the retail store chain Target™ has deployed an indoor positioning system available commercially from Acuity.

Indoor positioning technology providers typically charge more for their service than many venue owners are typically willing to spend. In many cases this is because the venue owner has limited capability to recoup indoor positioning technology costs unless they have adequate scale in the form of App users. For example, the Target™ App has over 10,000,000 users and thus Target™ can recoup indoor positioning technology costs much better than a small mom-and-pop store. This is exacerbated by the fact that when a venue has a limited number of App users, they are limited in what they can achieve because not enough location detail records (LDRs) are collected sufficient to provide a meaningful return on their investment in their indoor positioning technology.

To understand more fully the meaning and value of monitored indoor locations of mobile devices, the present invention provides a unique set of capabilities that conventional location companies do not have. Traditional location methods can only provide venue level information (e.g., that the mobile device was at an ACME home improvement store, that the mobile device was at the Dulles Airport, etc.) and not the granularity that marketers and advertisers might want to get (e.g., what products did the mobile device user view or dwell on; what food products did the mobile device user dwell upon while at the Dulles Airport, etc.)

In accordance with the invention, indoor positioning location detail records (LDRs) are collected; value is added to the indoor positioning location detail records (LDRs) by enrichment; and the enriched indoor positioning location data records may then be marketed and monetized.

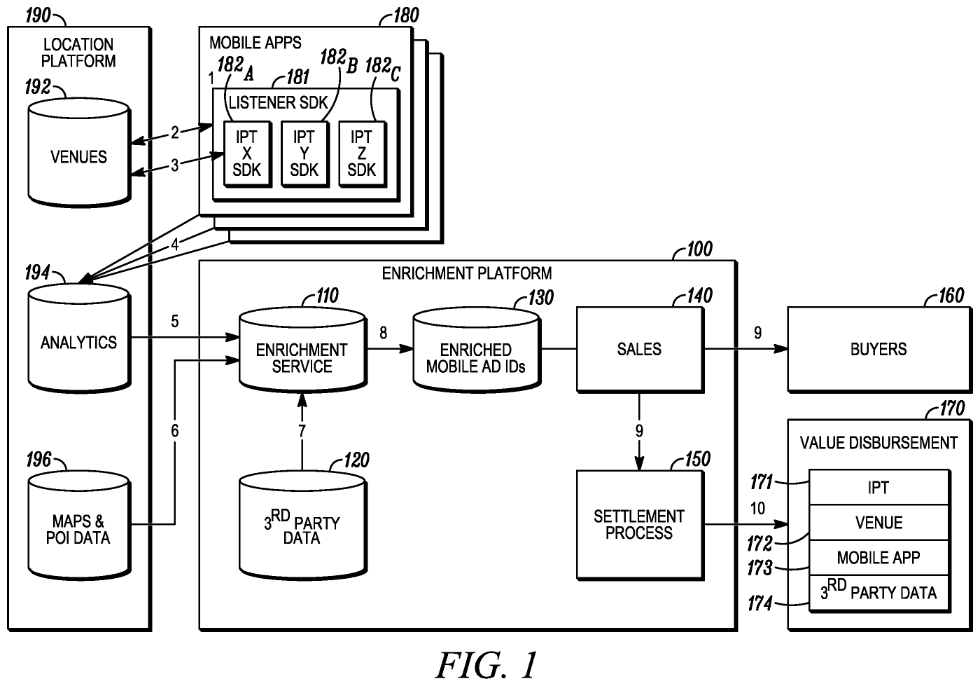

FIG. 1 shows an exemplary enrichment platform including an enriched Mobile Ad ID database, in accordance with an embodiment of the invention.

In particular, as shown in FIG. 1, an enrichment platform 100 includes an enriched Mobile Ad ID database 130, which is built by an enrichment service 110.

The enriched Mobile Ad ID database 130 takes in records, typically in a large batch, with mobile device location and timestamp associated with a given MAID. Each Mobile Ad ID row in the Mobile Ad ID database 130 is annotated in additional database columns with, e.g., a list of places that the mobile device dwelled, and places that the mobile device walked past (viewed) but didn't dwell. Dwell annotation and viewed annotation information in the enriched MAID database 130 preferably includes information having specific relevance to retail endeavors, e.g., what products are on a shelf in a dwell location, what products were walked past, etc.

Given the number of mobile users, data aggregators which collect the location detail records (LDRs) have the potential to end up collecting a large amount of data during SDK listening interactions with apps that monitor mobile device locations. The data aggregators create groups (“audiences”) with the LDRs, that are then sold to advertisers.

The inventor has appreciated that user location information, regardless of the source (e.g., conventional provision of Mobile Ad IDs with core location data, or location provided by indoor positioning technologies (IPT)), requires context to be valuable. The present invention adds a significant amount of value to such Mobile Ad IDs by adding indoor context to each Mobile Ad ID. For instance, location is used to create correlation among things, e.g., person is in Seattle, at a Target retail store, Aisle 6, Section B1.

In accordance with the present invention, the enrichment service 110 uses indoor positioning information to enrich location detail records (LDRs). The location detail records are provided by a selected or otherwise designated indoor positioning technology (IPT) (if more than one IPT is available within a given venue). The LDRs may be visualized on an indoor map of the relevant retail location to show a mobile device shopper's path and dwell locations within the given retail location.

The present invention builds an enriched MAID database 130 that includes entries of Mobile Ad IDs that contain not only a column of location information, but also additional columns including indoor context information for the location information. This enrichment of Mobile Ad IDs makes the generated enriched MAID database 130 much more valuable for targeted marketing and advertising, and thus capable of being marketed at a premium, making costs easier and quicker to recoup by venues that implement an indoor positioning technology (IPT) in support of the enrichment.

For example, using existing location technologies it may be possible to presume that a particular ad was viewed by a user carrying a given mobile device as it was carried past an ad in an airport. But in this conventional scenario the particular gate or retail location inside the airport is not known, nor is the mobile device's behavior before and after the advertisement was viewed. In accordance with the present invention, each Mobile Ad ID is enriched with indoor context that may include a point of interest (POI) logged in a map and point of interest (POI) database 196 such as the gate number within the airport, the identity of the airline currently using that gate at the time of the MAID, etc.

The addition of indoor context to core location data to create an enriched Mobile Ad ID database 130, i.e. enrichment, adds a new layer of information to a Mobile Ad ID database which is critical to more fully understanding consumer behavior. With such enrichment retail locations, not only can advertising companies be more competitive and cost effective with use of the enriched MAID information, but the venue hosting the indoor positioning technology (IPT) can provide their customers and App users with more meaningful experiences.

Enriched location detail records (LDRs) are indexed in the enriched Mobile Ad ID database 130 by MAID, ranked and sorted by indoor positioning technology (IPT), and made available for purchase or other monetary-based arrangement. Preferably each MAID entry in the enriched Mobile Ad ID database 130 includes columns identifying each of the parties that contributed to the enrichment.

For example, based on location detail records (LDRs) collected from: one or more App publishers; one or more venue maps; and/or one or more indoor positioning technology providers, enriched MAID data indicates that a particular MAID “98” has an affinity for women's apparel.

Also, for the same MAID “98”, higher fidelity insights may be drawn by focusing on higher confidence results based on higher accuracy indoor positioning. Presumably, this higher fidelity record has a different market value than simply an affinity for “women's apparel”. For instance, MAIN “98” can also have an affinity for denim pants with a tendency toward brands “AG™” and “7 FOR ALL MANKIND™”, as determined by: (a) LDR records collected by Snipsnap; (b) Map data from a suitable database; (c) indoor positioning technology data from a given source (e.g., Acuity); or (d) product data contributed by the venue or retail chain (e.g., by Macy's).

Given a high volume of data collection across millions of MAIDs, groups of MAIDs (“Audiences”) that share one or more common affinities may be created.

Enrichment of the location detail records (LDRs) preferably includes attributes added to the output files that indicate level of contribution that an app, a venue, an indoor positioning technology (IPT) had in the final enriched record.

The enrichment service 110 compares input location information otherwise included in a conventional Mobile Ad ID, with indoor context input from a third party data database 120.

The maps and point of interest (POI) database 196 stores a collection of accurate and up-to-date indoor maps used by the enrichment platform 100 to add indoor context to, i.e., “enrich” location detail records (LDRs) obtained from a third party mobile location logs maintained in a database 120.

An analytics database 194, and an indoor maps and point of interest (POI) database 196 associated with a location platform 190 are also provided to the enrichment service 110.

Analytics stored in the analytics database 194 enable derivation of insights from these millions and millions of MAID records so as to obtain the most value out of all of the data generated.

The enrichment platform 100 provides a system that is capable of constantly learning and refining it's algorithms based on new patterns in the data.

Using detailed indoor location information stored in the Maps and POI database 196, the enrichment platform 100 identifies a specific point of interest (POI) where an ad was viewed (not just raw data coordinates), how long a mobile device user remained at that specific POI (e.g., gate 12 at Dulles International Airport), and where the mobile device user was located immediately prior to and after viewing the ad, all of which is invaluable in gaining a better understanding of the mobile device user (and thus providing more value to the MAIDs contained within the enriched Mobile Ad ID database 130.

Of course, other information may also be stored in the Mobile Ad ID database 130 and associated with MAIDs, in accordance with the principles of the present invention. For instance, with fixture information and product placement information stored within the maps and POI database 196, the MAID may be enriched with information such as specific products that were viewed during a dwell, specific products that were walked past immediately before and/or after the dwell, etc.

Moreover, enrichment information may be stored for only some (and not all) of the Mobile Ad IDs in the enriched Mobile Ad ID database 130.

The enrichment platform 100 enables bulk processing. Given the number of active mobile users viewing apps and mobile web, millions and millions of MAID records are constantly being created. As these records are mostly used in offline use cases to gain an enhanced understanding of users and how to target them, the ability to add detailed location to a large amount of records is highly valuable.

The enriched Mobile AD ID database 130 provides enriched location data that can be marketed/sold as depicted by sales 140 that are made to buyers 160.

The invention preferably further provides a mechanism by which a settlement process 150 can be performed between interested parties. The settlement is preferably made via a value disbursement process 170 including parties such as the indoor positioning technology (IPT) provider 171, the venue 172, the mobile app 173, and/or a provider of third party data 174.

The location detail records (LDRs) may be marketed and sold (e.g., directly to advertisement platforms by creating audiences, or through other channels). In particular, individualized settlement of the money made through sales are handled based on the various vested participants' in the value chain. Example vested participants in sales of enriched location detail records (enriched MAIDs) may include: (a) The venue 172 in which the mobile device's location records were captured; (b) The indoor positioning technology (IPT) provider 171 that created the location detail records; (c) The app publisher 173 that published the SDK and embedded the listener SDK that captured the location detail records (LDRs); and/or (d) Third party data providers 174 of the third party database 120 used for enrichment of the LDRs may also be an invested participant.

Note that not all participants need to, or necessarily will participate in settlement. The invention provides the capability for a system and method for making such settlement identifiable and achievable. Actual settlement is preferably determined through business contracts based on a location as defined by an appropriate venue map.

A mobile app 180 running on a users' mobile device includes an embedded listener SDK 181 for a selected Indoor Positioning Technology (IPT). The listener SDK 181 function may include capability to obtain location from any of more than one available indoor positioning technology. Depending upon which IPT is selected or otherwise designated, the listener SDK 181 comprises an activated or enabled one of the available IPT SDKs 182a, 182b, 182c.

The listener SDK 181 communicates with indoor positioning technology within the relevant venue. A database of venues 192 is maintained in the location platform 190. A mobile device user may have only one IPT available, in which case it is a default. In some venues a mobile device user may have a plurality of IPTs available, in which case on of the plurality of available IPTs 182a, 182b, 182c is selected for activation or otherwise designated and enabled.

The listener software developer kit (SDK) 181 is created and distributed to app publishers for passage to mobile devices. The indoor positioning technology (IPT) SDK may be pre-installed as part of a branded SDK 181 or, to optimize the size of the SDK 181, the IPT SDK 182a, 182b or 182c can be downloaded over-the-air (OTA) and installed dynamically only when needed.

The app publishers embed the SDK 181 in a relevant mobile device. There are two possible implementations for distributing embedded SDKs: In a first embodiment the app publisher can embed listener SDKs from a variety of indoor positioning technologies (IPT) which calculate the position on a mobile device. In this way a listener SDK is embedded in a mobile device (or pre-integrated for later download and installation in the mobile device) that uses a particular indoor positioning technology from a variety of indoor positioning technologies that calculate the position on the mobile device itself. Alternatively, in a second embodiment the listener SDK listens for the raw signals that are needed as inputs by indoor positioning technologies, and sends the raw signals back to a server so that the mobile device's indoor position can be calculated server-side.

The listener SDK 181 determines when an alternate indoor positioning technology should be used. The listener SDK 181 is preferably periodically updated with identification and location of which venues around it are enabled with alternate indoor positioning technologies.

The listener SDK 181 may monitor location accuracy. If the location accuracy becomes inaccurate (beyond a predetermined threshold accuracy) for a significant duration, then the listener SDK 181 may request an alternate indoor positioning technology be determined.

The listener SDK 181 preferably pre-integrates several indoor positioning technologies solutions. The indoor positioning technology solutions may be distributed with the listener SDK 181 or installed over-the-air (OTA).

Location detail records (LDRs) (“Analytics”) are collected by the listener SDK 181 and transmitted to a server via a service call. The location detail records (LDRs) include the indoor positioning technology (IPT) (e.g., Google Core Location, Indoor Atlas, Acuity, etc.) The location detail records and analytics records include the venue and an ID to identify the app. These three elements are necessary for revenue settlement.

Both background and foreground methods are considered. For instance, if background and location accuracy is, e.g., greater than 20 meters, position relative to the venue is checked with indoor positioning technology. If the position is in or near a given venue, the position is re-captured using the designated indoor positioning technology.

Preferably a local list of points of polygons is pre-downloaded and maintained for repeated comparison to a stream of location detail records (LDRs) being monitored. For instance, if near latitude/longitude position 12.234 56.7809, the mobile device is inside a given polygon (say “polygon_1234”) and therefore the indoor positioning system that is designated for use is determined to be, e.g., “IPT_Y”.

Additional location technology may be implemented for nearby venues. For instance, U.S. Pat. No. 9,510,145 entitled “Battery-Saving in Geo-Fence Context Method and System”, co-owned by the Assignee of the present application, discloses a geofence. U.S. Pat. No. 9,510,145 is explicitly incorporated in its entirety by reference.

The venue database 192 preferably maintains database records for each venue regarding the identify of indoor positioning technologies (IPTs) that are available at each venue (e.g., indoor retail location). Venue location stored in the venue database 192 may be the centroid for the center of the venue, or a rectangular box around the venue, or a complex polygon representing the shape of the venue or substructures within the venue (e.g., an airport terminal building).

The venue database 192 may further include a ranking for each venue record as to predetermined factors relating to each indoor positioning technology available at a given venue. Example predetermined factors include performance, accuracy, availability, coverage, and cost.

A record is maintained of which indoor positioning technologies (IPTs) are available at each venue. For a given venue, a determination is made as to which of the available indoor positioning technologies (IPTs) is to be used as the positioning provider for a given venue.

For instance, preferably the IPT having a highest ranking for any given venue is designated for use by the mobile app 180. In one disclosed embodiment, this determination is made based on several predetermined factors (such as performance, accuracy, availability, cost). Thus, the determination as to which of the available indoor positioning technologies is to be used is preferably made not as a technology which necessarily provides a “best” indoor position. Rather, the designated indoor positioning technology is preferably determined based on other factors, such as those indoor positioning technologies that have an invested interest for use of their indoor positioning technology, or a determination based on performance (accuracy of the indoor location), and also based on “cost” in the sense that an IPT is able to set a price for third parties that want access to location records created by their technology. Alternatively when multiple IPTs are available to generate location detail records (LDRs), this “cost” may preferably be based on a bid system, which is especially useful in real-time location based advertising scenarios.

Alternatively, the designated indoor positioning technology (IPT) may be pre-installed as part of the listener SDK installed in mobile devices.

To optimize the size of the listener SDK, the designated indoor positioning technology (IPT) may be downloaded over-the-air (OTA) and installed dynamically only when needed, though this is more difficult because App stores don't conventionally allow an App to update itself OTA.

The indoor positioning location detail records are collected from whichever indoor positioning technology (IPT) was determined, and enriched preferably at a summary level by unique mobile identifier Device ID (Mobile Ad ID).

Indoor positioning location detail records (LDRs) are collected from whichever indoor positioning technology (IPT) was selected. Indoor positioning location detail records (LDRs) may be collected from all App publishers using every indoor positioning technology that was selected or otherwise designated by the listener SDK. The location detail records (LDRs) are processed by Device ID (e.g., Mobile Ad ID or other appropriate and unique identifier) of the mobile device.

To pinpoint a mobile device user and understand their location behavior inside a large venue requires a deep set of knowledge about the venue. For example in a shopping mall, the invention appreciates that being able to identify that the mobile device dwelled and saw an ad in front of store “X”, and that the mobile device user then went to store “Y”, is very important. The invention also appreciates that it is interesting (and thus valuable) to know how long a mobile device user dwelled (stopped) at a particular MAID location. To provide these valuable functions the enrichment platform 100 uses a detailed spatial understanding of the mall obtained from the maps and point of interest (POI) database 196 to enrich the MAIDs triggered by the relevant mobile device while in the mall. In this way the MAID entry in the enriched Mobile Ad ID database 130 is enriched with information stored in additional columns that the ad was seen in front of store “X”, and then that the mobile device user went to store “Y”.

The MAID entry in the Mobile Ad ID database 130 is preferably enriched with additional information such as that the mobile device Dwell information (locations where the mobile user paused or otherwise temporarily stopped moving) is also added to the enriched Mobile Ad ID database 130.

The present invention also preferably has the ability to build an enriched Mobile Ad ID database 130 that includes a priori information regarding a MAID. For instance, for a given MAID, the entry may be enriched with a column indicating a point of interest where the mobile device user last dwelled immediately prior to the triggering of the MAID, such as the mobile device user was at store “W” before viewing the ad in front of store “X”.

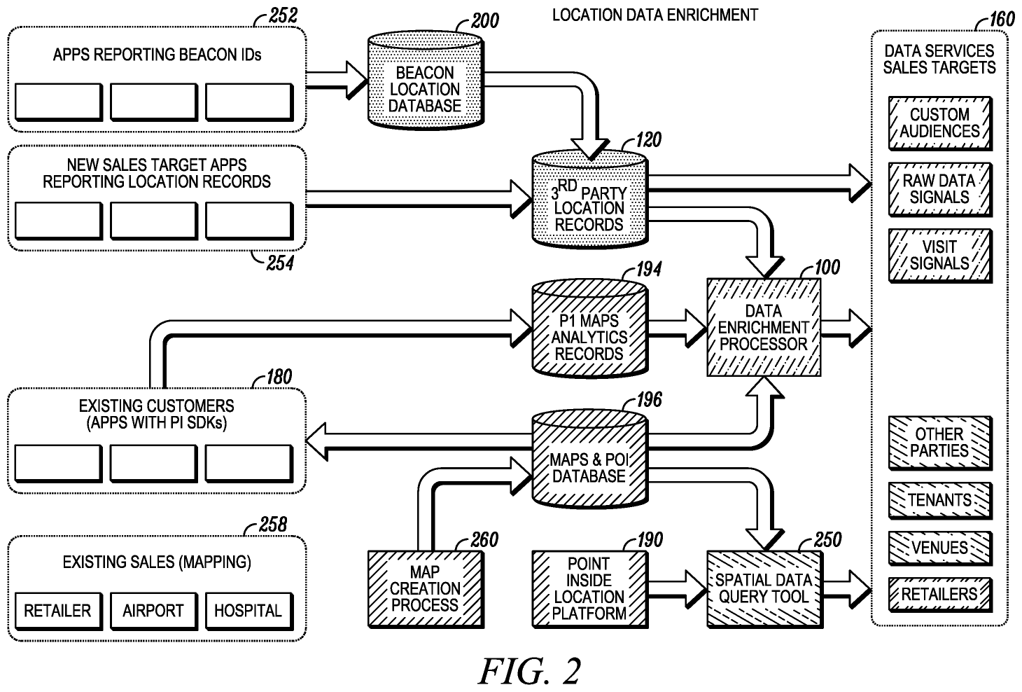

FIG. 2 shows flow relevant to the enrichment platform.

Importantly, the location detail records (LDRs) relevant to Mobile Ad IDs are enriched by the enrichment platform 100. For instance, in disclosed embodiments enrichment is performed either (a) by associating the location detail records (LDRs) to maintained maps and point of interest (POI) data, and/or (b) by associating the LDRs to third party data.

To improve accuracy of the indoor position, existing location beacons may be leveraged as a proxy for location. In such a scenario a beacon location map is required, or a survey may be performed to capture this data. Alternatively, a basic indoor positioning system may be provided for use in their app (e.g., indoor atlas). Intersections of a retailer's location data may be mapped with fixtures/items on the shelf. Intersections of other data from the retailer (e.g., POS, web clicks) may be mapped with fixtures/items on the shelf.

As shown in FIG. 2, the third party location records database 120 is bunt with information from multiple sources, such as a beacon location database 200 that contains location data reported from apps with beacon Ds 252. The third party location records database 120 may also contain location records from other apps which report location records using other technologies. The third party location records provide important enrichment data for use by the data enrichment platform 100 in building MAID records with enriched value suitable for sales to data services sales targets 160 which use, e.g., custom audiences, raw data signals, and visit signals.

Indoor locations which are most suitable for use of the enriched MAID information include retailers, venues, tenants, and other parties.

The maps analytics records database 194 obtains records from the mobile apps 180 with the embedded listener SDK 181. The analytics records are input to the enrichment platform 100 for use in generating enriched information to be added to one or more columns of the enriched Mobile Ad ID database 130.

The maps and point of interest (POI) database 196 contains existing map and POI information 258, as well as maps and POI information created through a map creation process 260. The maps and POI database 196 provides map and POI information to the enrichment platform 100. The maps and POI information may also be used by the mobile apps 180, and/or for use by a spatial data query tool 250. The spatial data query tool 250 receives input from an appropriate location platform 190.

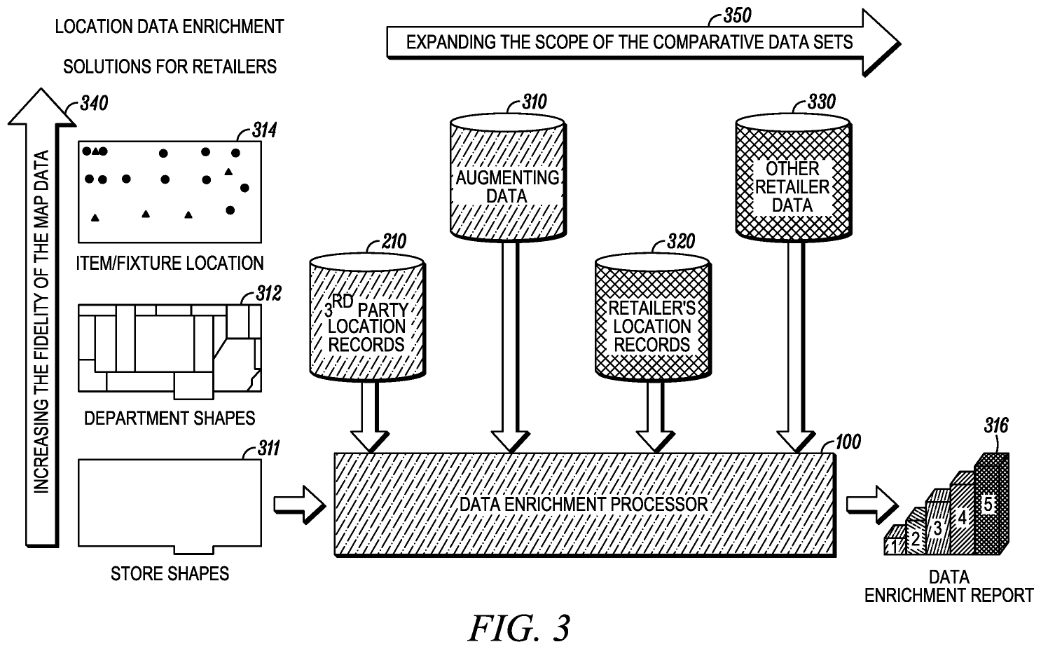

FIG. 3 depicts a layered value approach to enrichment of MAID information by the enrichment platform 100.

For instance, as shown in FIG. 3, the enrichment platform 100 can use a variety of levels of fidelity of input map data 340, from a coarse level relating merely to location within a store shape 311, to a mid-fidelity level representative of location information identifying department shapes 312, to a high fidelity level representative of location information identifying an item and fixture location within an indoor space 314.

The variety of levels of fidelity of enrichment are provided by a feathered use of available enrichment information 350, including a third party location records database 210, a database of augmenting data 310, a retailer's location records database 320, and/or a database of other retailer data 330.

With the varying levels of fidelity a corresponding variety of enriched MAID reports 316 may be generated by the enrichment platform 100.

Table 1 represents an exemplary settlement process 150 by function with examples for three possible MAID groups created on different value chain participants.

TABLE 1

| | | Low Fidelity MAID Group | | | | Medium Fidelity MAID Group | | | | High Fidelity MAID Group | | | |
|---|---|---|---|---|---|---|---|---|---|---|---|---|---|
| | | (no IPT & no 3rd party data) | | | | (using IPT but no 3rd party data) | | | | (using both IPT and 3rd party data) | | | |
| | | $6 | | | | $9 | | | | $15 | | | |
| | | $ 6,000 | | | | $ 9,000 | | | | $ 15,000 | | | |
| | CPM | 1,000,000 | | | | 1,000,000 | | | | 1,000,000 | | | |
| | Revenue | | Std | ProRata | Total | | Std | ProRata | Total | | Std | ProRata | Total |
| | MAIDs | | Share | Share | Share | | Share | Share | Share | | Share | Share | Share |
| App Publisher | 40% | 40% | $2,400 | [symbol] | $4,084 | 40% | $3,600 | $935 | $4,535 | 40% | $6,000 | $0 | $6,000 |
| Indoor Positioning | | | | | | | | | | | | | |
| Provider | | | | | | | | | | | | | |
| free from [symbol] | 0% | 0% | $0 | $0 | $0 | | | | | | | | |
| IPT | 20% | | | | | 20% | $1,800 | $468 | $2,268 | 20% | $3,000 | $0 | $3,000 |
| Mapping Provider | 5% | 5% | $300 | $211 | $511 | 5% | $450 | $117 | $567 | 5% | $750 | $0 | $750 |
| 3rd Party Data | 15% | | | | | | | | | 15% | $2,250 | $0 | $2,250 |
| Provider | | | | | | | | | | | | | |
| 3rd Part Data | 5% | | | | | | | | | 5% | $750 | $0 | $750 |
| Spatial Indexing | | | | | | | | | | | | | |
| MAID Scoring & | 12% | 12% | $720 | $505 | $1,225 | 12% | $1,080 | $281 | $1,361 | 12% | $1,800 | $0 | $1,800 |
| Sales | | | | | | | | | | | | | |
| Settlement | 3% | 3% | $180 | n/a | $180 | 3% | $0270 | n/a | $270 | 3% | $450 | n/a | $450 |
| Pro-rata | 0% | 40% | $2,400 | | | 20% | $1,800 | | | 0% | $0 | | |

[symbol]

indicates data missing or illegible when filed

In Table 1 the pro rata line is the amount split across the contributing value chain participants should there be money in excess of the collected amount. The pro rata amount may be calculated based on the percent of the contribution of the various value chain participants (VCPs).

In the first scenario shown in Table 1, no indoor positioning technology and no third party data was used to enrich the MAID group. This share of the exemplary revenue ($2400) is divided amongst the active value chain participants not including the settlement service provider. Using the standard distribution percentages, 40/57 of the pro rata amount is paid to the App publisher; 8/57 of the pro rata amount is paid to the mapping provider; and 9/57 of the pro rata amount goes to the provider of the enrichment services.

In the second scenario shown in Table 1, no third party data was used to enrich the MAID group. This share of the revenue ($1350) is divided amongst the active value chain participants not including the settlement service provider. Using the standard distribution percentages, 40/82 of the pro rata amount is paid to the App publisher; 8/82 of the pro rata amount is paid to the mapping provider; 9/82 is paid to the provider of the enrichment services; and 25/82 of the pro rata amount is paid to the indoor positioning technology provider.

In the third scenario shown in Table 1, all participants were active in the value chain therefore no pro rata amount is available for sharing.

In all three scenarios shown in Table 1 the settlement is further split by multiple parties within each category of the value chain. For instance, in the third scenario shown in Table 1 within App Publishers, we might find that the location detail records (LDRs) originate from three different publishers. In this case the relevant fraction of the pro rata share of the settlement would be based on whatever percent of the location detail records (LDRs) that each App publisher contributed.

As an example, App #1 contributed 10,000,000 location detail records (LDRs) that were used to create this MAID Group. App #2 contributed 20,000,000 location detail records (LDRs). App #3 contributed 70,000,000 location detail records (LDRs). As a result, App #1 would receive 10% of the App publisher's fraction of the pro rata share; App #2 would be apportioned 20% of the App publisher's fraction of the pro rata share; and App #3 would be apportioned 70% of the App publisher's fraction of the pro rata share.

The same apportionment may be used for all value chain participants, preferably with the exception for MAID enrichment and settlement.

The invention may be implemented in a location platform 190 such as those which are described in co-pending U.S. application Ser. No. 15/702,595 entitled “Location Assignment System and Method”; U.S. application Ser. No. 15/833,402 entitled “Transaction Based Location Assignment System and Method”; in U.S. application Ser. No. 15/868,913 entitled “Shopper Traffic Flow Visualization Based on Point of Sale (POS) Transaction Data”; and/or in U.S. application Ser. No. 15/869,018 entitled “Shopper Traffic Flow Spatial Analytics Based on Indoor Positioning Data”; and U.S. application Ser. No. 15/814,308 entitled “Location Assignment System and Method”, the entirety of all of which are expressly incorporated herein by reference.

The location platform 190 is preferably enhanced by modification of a maps library SDK to include a listener SDK 181. Unnecessary libraries may be removed from the location assignment system as described in the above US patents and applications, and a focus is placed on the location manager (“LM”). The LM is preferably available to mobile device users of the listener SDK 181 to plug-in alternate indoor positioning technology (IPT) SDKs 182a, 182b, 182c. The location manager (LM) pulls location from core location and any installed indoor positioning technology (IPT) SDK 182a, 182b, 182c. The LM preferably is database driven for rules related to determination of which indoor positioning technology (IPT) is designated to be used.

The indoor positioning technology (IPT) database records include attributes that include information that the location manager (LM) uses to determine the indoor positioning technology to be used. The service API for the venue object (indoor maps) also preferably includes information that the location manager uses to determine the indoor positioning technology to be used. This may also serve as the end-point for the location manager to download an indoor positioning technology that has been determined to be used but is not currently installed.

TABLE 2

| Prior Art | Invention |
|---|---|
| MAID 1 | MAID 1 |
| Dwell inside Bellevue Square | Notable Dwells while inside Bellevue |
| for 150 minutes | Square for 2.5 hrs: |
| Dwell inside Sea-Tac Airport | 32 minutes at electronics store, Apple |
| for 85 minutes | store |
| Dwell inside Chicago ORD | |
| for 22 minutes | |

Combining an extensive catalogue of indoor maps and POI information contained in the maps and POI database 196, the invention accurately adds indoor context and indoor location to MAID records providing an enriched Mobile Ad ID database 130 with information having a much greater level of detail and context when it comes to understanding where mobile device users were located when inside a building or other indoor structure or POI. The invention also has the added benefit of collecting location data and indoor context from existing mobile apps including the SDK 181, which contribute additional information and insight added to columns of MAID entries in the enriched Mobile Ad ID database 130, in accordance with the invention.

Table 3 below illustrates exemplary enrichment of a particular Mobile Ad ID (MAID) entry within the enriched Mobile Ad ID database 130. While depicted as a singular column within the Mobile Ad ID database 130, the enriched data preferably occupies multiple columns within the Mobile Ad ID database 130.

TABLE 3

| | |
|---|---|
| MAID entry | 18 minutes near restaurant, Great |
| | State Burger |
| | 90 minutes at anchor store, Macy's |
| | 3 minutes at TUMI |
| | Other Impressions inside Bellevue |
| | Square: |
| | Trueform, Finish Line, Seattle |
| | Team Shop, OROGOLD, |
| | Sunglass Hut, Gymboree, American Eagle, |
| | Notable Dwells while inside Sea- |
| | Tac Airport for 85 minutes |
| | 4 minutes in Parking |
| | 6 minutes at Security Checkpoint 3 |
| | 8 minutes at restaurant Dilettante Mocha |
| | 17 minutes near Gate D10, American |
| | Airlines to Chicago ORD |
| | Notable Dwells while inside Chicago ORD |
| | 8 minutes at rideshare pick-up location. |

There are two main variables from which the invention creates insights. The first is the fidelity of the maps used to show spatial context. At its most basic level a map may show the outline of a mall or of a retail store. Using the present invention's mapping capability, those spaces can be subdivided, e.g., into stores in the mall or departments in the retail store. Levels of detail may be added to the map that ultimately takes us to picture/display table level insights.

The second variable is the data that is attributed to each shape that is created on the map. A common type of data are location records which can come from a variety of sources including (1) companies that collect and distribute this data; (2) customer apps that collect this data; and (3) customer apps that use the inventive SDKs. Other data can also be attributed to either the location record (typically identified by a MAID), the sub-polygon or other data associated with the shapes. These smaller shapes are often associated with a store (in a mall) or a planogram (in a retailer). Additional nested layers of associations can be created as well. For instance:

Mall

Mall→Retailer

Mall→Retailer→Department

Mall→Retailer→Department→Planogram→Section→Shelf→Item

Mall→Retailer→Department→Planogram→Item→Brand

Mall→Retailer→Department→Planogram→Item→Category

Mall→Retailer→Department→Planogram→Item→Price

Mall→Retailer→Department→Planogram→Item→Promotion

Airport

Airport→Services

Airport→Services→Gate

Airport→Services→Gate→Airline

Airport→Services→Gate→Airline→Destination

Airport→Services→Gate→Airline→Status

Airport→Tenant→Concessions→Restaurant

Airport→Tenant→Concessions→Restaurant→Mexican

Airport→Tenant→Concessions→Restaurant→Liquor, Beer and Wine

Airport→Concessions→Shop

Airport→Concessions→Shop-->Apparel

App publishers may be, e.g., Yelp!, Delta, Uber, RetailMeNot, etc.

Venue owners may be, e.g., retailers, malls, airports, etc.

Publicly available data may be compared to store polygons to identify mobile device users that are near and inside the relevant stores. This data may be contained within the maps and POI database 196, and augmented with demographic information.

In some disclosed embodiments, retailers may provide floor plans from which department shapes may be made to identify mapped departments and stored in the maps and POI database 196.

The present invention has applicability to indoor positioning technology and systems, and particularly applicability to indoor venue owners and operators of, e.g., malls, retails, airports, etc.

The invention also has applicability to data service companies that provide a current-technology istener SDKs 181 to app providers (e.g., AREA METRICS™, CUEBIG™).

The invention is also applicable to app publishers that install third party SDK listeners 181 into their apps (e.g., PELMOREX™, EXPEDIA™, UBER™).

The invention has further applicability to advertisers (purchasers of MAIDs for the purpose of advertising to specific audiences); to data aggregators who re-distribute MAID data and may enrich in other ways; to financial institutions that use mass mobile data as part of their decisioning on stocks; and to retailers who could use this data for improved personalization for their shoppers.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

Unless the context clearly requires otherwise, throughout the description and the claims, references are made herein to routines, subroutines, and modules. Generally it should be understood that a routine is a software program executed by computer hardware and that a subroutine is a software program executed within another routine. However, routines discussed herein may be executed within another routine and subroutines may be executed independently, i.e., routines may be subroutines and vice versa. As used herein, the term “module” (or “logic”) may refer to, be part of, or include an Application Specific Integrated Circuit (ASIC), a System on a Chip (SoC), an electronic circuit, a programmed programmable circuit (such as, Field Programmable Gate Array (FPGA)), a processor (shared, dedicated, or group) and/or memory (shared, dedicated, or group) or in another computer hardware component or device that execute one or more software or firmware programs or routines having executable machine instructions (generated from an assembler and/or a compiler) or a combination, a combinational logic circuit, and/or other suitable components with logic that provide the described functionality. Modules may be distinct and independent components integrated by sharing or passing data, or the modules may be subcomponents of a single module, or be split among several modules. The components may be processes running on, or implemented on, a single computer, processor or controller node or distributed among a plurality of computer, processor or controller nodes running in parallel, concurrently, sequentially or a combination.

While the invention has been described with reference to the exemplary embodiments thereof, those skilled in the art will be able to make various modifications to the described embodiments of the invention without departing from the true spirit and scope of the invention.

What is claimed is:

1. An enriched mobile Ad ID database, comprising:
a plurality of location detail record rows corresponding to a marketing-based event, each of the plurality of location detail record rows including a plurality of columns, the plurality of columns comprising:
a Mobile Ad ID (MAID);
a location of the MAID;
a timestamp of the MAID;
a place name associated with a location of the Mobile Ad ID; and
at least one indoor context descriptor;
wherein the at least one indoor context descriptor enriches the respective one of the plurality of location detail records to provide a basis for grouping sub-pluralities of the plurality of location detail record rows.

2. The enriched mobile Ad ID database according to claim 1, wherein the at least one indoor context descriptor comprises:
an identity of a place where the mobile device which triggered the MAID last was immediately before the MAID.

3. The enriched mobile Ad ID database according to claim 2, wherein the at least one indoor context descriptor further comprises:
an identity of a place where the mobile device which triggered the MAID next was immediately after the MAID.

4. The enriched mobile Ad ID database according to claim 1, wherein the at least one indoor context descriptor comprises:
an identity of a place where the mobile device which triggered the MAID next was immediately after the MAID.

5. The enriched mobile Ad ID database according to claim 1, wherein the at least one indoor context descriptor comprises:
a retail brand last dwelled on by the mobile device user immediately before the MAID.

6. The enriched mobile Ad ID database according to claim 5, wherein the at least one indoor context descriptor further comprises:
a retail brand next dwelled on by the mobile device user immediately after the MAID.

7. The enriched mobile Ad ID database according to claim 1, wherein the at least one indoor context descriptor comprises:
a retail brand next dwelled on by the mobile device user immediately after the MAID.

8. The enriched mobile Ad ID database according to claim 1, wherein:
the marketing-based event is an indication that a mobile device dwelled on a particular retail presentation.

9. The enriched mobile Ad ID database according to claim 8, wherein:
the retail presentation is an advertisement.

10. The enriched mobile Ad ID database according to claim 8, wherein:
the retail presentation is a displayed retail product.

11. A method of building an enriched mobile Ad ID database, comprising, for each of a plurality of mobile Ad IDs maintained within the enriched mobile Ad ID database:
generating a location detail record row within the mobile Ad ID (MAID) database with a mobile Ad ID stored in a first column of the generated location detail record row;
storing in a second column of the generated location detail record row a location detail record (LDR) associated with the mobile Ad ID; and
enriching the mobile Ad ID by storing in one or more additional columns of the generated location detail record row at least one indoor context descriptor associated with the MAID, the at least one indoor context descriptor providing a basis for grouping the location detail record row with other location detail record rows.

12. The method of building an enriched mobile Ad ID database according to claim 11, further comprising:
embedding a listener SDK in a given mobile device.

13. The method of building an enriched mobile Ad ID database according to claim 12, wherein the listener SDK obtains location of the given mobile device using a given indoor positioning technology.

14. The method of building an enriched mobile Ad ID database according to claim 11, wherein the at least one indoor context descriptor comprises:
an identity of a place where the mobile device which triggered the MAID last was immediately before the MAID.

15. The enriched mobile Ad ID database according to claim 11, wherein the at least one indoor context descriptor further comprises:
an identity of a place where the mobile device which triggered the MAID next was immediately after the MAID.

16. The enriched mobile Ad ID database according to claim 11, wherein the at least one indoor context descriptor comprises:
a retail brand last dwelled on by the mobile device user immediately before the MAID.

17. The enriched mobile Ad ID database according to claim 11, wherein the at least one indoor context descriptor further comprises:
a retail brand next dwelled on by the mobile device user immediately after the MAID.

18. Apparatus for building an enriched mobile Ad ID database, comprising, for each of a plurality of mobile Ad IDs maintained within the enriched mobile Ad ID (MAID) database:
means for generating a plurality of mobile Ad ID rows within the enriched mobile Ad ID database;
means for storing a mobile Ad ID in a first column of each of the plurality of generated plurality of mobile Ad ID rows;
means for storing a location detail record (LDR) associated with the mobile Ad ID, in a second column of each of the plurality of mobile Ad ID rows; and
means for enriching the mobile Ad ID row by storing in one or more additional columns of the mobile Ad ID row at least one indoor context descriptor associated with the MAID, the at least one indoor context descriptor providing a basis for grouping the mobile Ad ID row with other mobile Ad ID rows.

19. A method of selecting an indoor positioning system for use in creation of a given mobile Ad ID, comprising:
maintaining in a database a plurality of indoor positioning systems available at each of a respective plurality of venues;
ranking the plurality of indoor positioning systems for each of the respective plurality of venues based on a cost of each;
matching a record from among the plurality of records to a venue corresponding to a current position of a given mobile device;
determining a desired indoor positioning system from among the plurality of indoor positioning systems within the matching record, to transmit positioning for a given mobile Ad ID;
collecting a plurality of location detail records (LDRs) from the desired indoor positioning system; and
enriching the collected plurality of location detail records at a summary level by a unique mobile identifier device ID to form a mobile Ad ID.

20. The method of selecting the indoor positioning system for use in creation of the given mobile Ad ID in accordance with claim 19, further comprising:
pre-installing in a given mobile device the desired indoor positioning technology to be used prior to occurrence of the mobile Ad ID generated by the given mobile device.

21. The method of selecting the indoor positioning system for use in creation of the given mobile Ad ID in accordance with claim 20, wherein:
the pre-installing is performed over-the-air (OTA).
